(19) United States
(12) Patent Application Publication
(10) Pub. No.: US 2024/0292942 A1
(43) Pub. Date: Sep. 5, 2024

(54) APPLICATOR DEVICE FOR APPLYING A PRODUCT OF FLUID OR PASTY TYPE TO KERATIN FIBERS

(71) Applicant: SOCIETE INDUSTRIELLE DE MATIERES PLASTIQUES, Tigery (FR)

(72) Inventor: Eric DE BARDONNECHE, Montaren-et-Saint-Mediers (FR)

(21) Appl. No.: 18/574,395

(22) PCT Filed: Jun. 29, 2021
(86) PCT No.: PCT/FR2021/051199

§ 371 Date: Dec. 27, 2023

(51) Int. Cl. A46B 9/02; A46B 1/00; A46D 1/00

(52) U.S. Cl. CPC A46B 9/021; A46B 1/00; A46D 1/0238; A46D 1/0253; A46B 2200/1053

(57) ABSTRACT

The application relates to an applicator device for applying a product of the fluid or pasty type to keratin fibres or to an epidermis, including a central core of elongate shape, which extends along a longitudinal axis XX, at least one row of elongate spikes including a first end embedded in the core and a second, free end, the spikes and the core being formed in one piece, at least one of the spikes being delimited by a first flat face coincident with a longitudinal plane passing through the longitudinal axis XX of the central core, referred to as the joint face, and by a second flat face that forms, with the first flat face, an angle of between 91° and 179°, delimiting a cosmetic product reservoir volume V.

### TECHNICAL FIELD OF THE INVENTION

The invention relates to the field of applicators for applying fluid or pasty cosmetic product to keratin fibers or to the skin, for example of the mascara type. The invention more specifically concerns the cosmetic product applicator device or means.

### PRIOR ART

Currently, a large number of mascara applicators are known from the prior art. The application device per se may be for example an elongate brush provided with a central core from which a set of bristles or spikes protrudes. The bristles are formed using a long-standing technique: a twisted metal wire retains bristles which protrude transversely. An exemplary application is illustrated in document US2011/030717.

According to another embodiment, the application device takes the form of a brush comprising a series of bristles embedded in the longitudinal core of the brush. The whole is molded from plastics material. An application device thus forms, with a suitable reservoir in which it can be inserted, a cosmetic product dispenser. Documents FR 2 810 860 and WO 2011/045770 disclose a few examples of applicators based on this concept.

The drawbacks of the application devices, or brushes, of the prior art are that the spikes do not make it possible to transfer the cosmetic product from the reservoir to the spikes correctly or to apply product suitably to the keratin fibers, in order to lengthen them, thicken them and/or separate them.

In the field of mascara applicators, one solution envisaged by the prior art to improve the load of mascara on the brushes consists in using spikes having a flat face to accommodate the mascara, while a non-flat face contributes to separating the eyelashes. Document EP 1 872 682 describes such a brush; the spikes are disposed in rows parallel to the longitudinal axis of the brush and all the spikes in a row have their flat face on the same side: the flat faces are aligned while the non-flat faces are on the same side of the line. The user of the brush thus makes the brush move in a direction perpendicular to the longitudinal axis of the brush, all the while rotating it.

The brushes of this type do not have maximum effectiveness because the flat faces do not contribute to optimum separation of the eyelashes and the non-flat faces do not contribute to the load of cosmetic product. With this type of brush, the user is therefore forced to pass it over the eyelashes several times, all the while reversing the movement of the brush to ensure enough load of cosmetic product is collected.

Somewhat differently, document EP 1 611 817 discloses a cosmetic product application device comprising a longitudinal support and first and second rows of spikes, which are made in one piece with the support, are embedded on one side of the support and extend over more than one quarter of the length of the support. The teeth (or spikes) extend on either side of a geometric “separation” surface formed with two non-parallel surface areas and directions. The spikes stand upright from a flat face of the support, and they are formed in staggered fashion on either side of the separation surface. As a result, when the cosmetic product is being applied, the back-and-forth movement that the brush is made to make does not allow optimum distribution of the load or suitable separation of the eyelashes.

Additionally, document FR 2 930 875 discloses a cosmetic product applicator device, comprising a longitudinal core supporting multiple rows of spikes which have a flat face and project radially from the core. The spikes are distributed in at least one row parallel to the longitudinal axis of the core such that, in one and the same row, the spikes are positioned alternately on either side of a central line (or plane) of the row, with their flat face facing toward the inside of the row. According to one feature of the invention, the flat faces of the spikes in one and the same row extend perpendicularly to the core and are aligned, and they are oriented in the two directions of rotation around the core.

Although this solution provides some improvement over the prior art, the modularity of the load is not obtained favorably. Moreover, the separation of the eyelashes can still be improved.

A development would therefore appear to be necessary notably in terms of the shape of each spike. Each spike should contribute to improving, on its own or in combination with other spikes, both the load of product and the separation of the eyelashes or keratin fibers.

### SUMMARY OF THE INVENTION

The invention aims to overcome the drawbacks of the prior art notably as regards the load of cosmetic product and the separation of the eyelashes.

To that end, what is provided according to the invention is an applicator device for applying a product of fluid or pasty type to keratin fibers or to the skin, comprising an elongate central core, which extends along a longitudinal axis XX, and at least one row of elongate spikes comprising a first end embedded in the core and a free second end, the spikes and the core being made in one piece, at least one of the spikes being delimited by a first flat face which coincides with a longitudinal plane passing through the longitudinal axis XX of the central core, referred to as joint plane, and by a second flat face forming an angle with said first flat face of between 91° and 179°, delimiting a reservoir volume V for cosmetic product.

These features, which constitute a precise technical definition of the individual and/or reciprocal disposition and shape of the spikes, improve the aforementioned functions.

Advantageously but optionally, the applicator device according to the invention has at least one of the following technical features:
the applicator device moreover has a third flat face forming an angle with said first flat face of between 1° and a value complementary to 180° of the angle minus 1°, the third flat face delimiting the reservoir volume V for cosmetic product that takes the form of a longitudinal groove;
a frustoconical face of the spike has first and second adjacent frustoconical sections, the second frustoconical section having an overthickness in relation to the first frustoconical section, with a longitudinal rim separating the two frustoconical sections;
the free end of the spike has a frustoconical part with an “overthickness” in relation to the rest of the frustoconical face of the spike, with an annular rim separating the frustoconical part with an overthickness from the rest of the frustoconical face;
the spike has first and second parts superposed, over some of each of their heights, one on the other along a longitudinal axis of the spike, the first part being delimited by the first and second flat faces, the second part protruding from the first part;
the second part has an overall shape mirror-symmetrical in relation to the first part;
the second part is superposed entirely over some of the height of the first part, between ends of the first part;
the spike has a third part superposed on the second part over some of each of their heights, one on the other along a longitudinal axis of the spike, the third part protruding from the second part;
the spike has elements protruding from an outer surface of the spike;
the spike has elements that are extending recessed from an outer surface of the spike;
at least two of the spikes making up a row have an identical orientation;
at least two of the spikes making up a row have a different orientation; and
the distance measured along the axis XX between two successive spikes may be negative, zero or positive, less than approximately 2 millimeters.

### BRIEF DESCRIPTION OF THE FIGURES

Further features and advantages of the invention will emerge on reading the following description with reference to the appended figures, in which:

FIG. 1 is a perspective view of an applicator device according to a first embodiment of the invention;

FIG. 2 is a detail view of an implantation of the spikes of the applicator device in FIG. 1;

FIG. 3a is a three-dimensional view of a first embodiment of a spike for the applicator device according to the invention;

FIG. 3b is a top view of the spike in FIG. 3a;

FIG. 4a is a top view of a set of five implantations of spikes in FIG. 1;

FIG. 4b is a top view of another set of five implantations of spikes in FIG. 1;

FIG. 5a is a three-dimensional view of a second embodiment of a spike for the applicator device according to the invention;

FIG. 5b is a top view of the spike in FIG. 5a;

FIGS. 6a and 6b are three-dimensional views of a first series of embodiment variants of the spike in FIG. 3a;

FIGS. 7a to 7c are three-dimensional views of a second series of embodiment variants of the spike in FIG. 3a;

FIGS. 8a to 8d are three-dimensional views of a third series of embodiment variants of the spike in FIG. 3a;

FIGS. 9a to 9d are three-dimensional views of a fourth series of embodiment variants of the spike in FIG. 3a;

FIGS. 10a and 10b are three-dimensional views of a third embodiment of a spike for the applicator device according to the invention;

FIG. 11 and FIG. 11b are three-dimensional views of a fourth embodiment of a spike for the applicator device according to the invention;

FIG. 11c is a three-dimensional view of an embodiment variant of the spike in FIG. 10a or 11a;

FIGS. 12a to 12d are three-dimensional, side and top, views of a fifth embodiment of a spike for the applicator device according to the invention;

FIG. 12e is a top view of an embodiment variant of the spike in FIG. 12a;

FIG. 13 is a side view of a second embodiment variant of the spike in FIG. 12a;

FIG. 14 is a three-dimensional view of an embodiment variant of the spike in FIG. 13;

FIG. 15a is a second embodiment variant of the spike in FIG. 13;

FIG. 15b is a fourth embodiment variant of the spike in FIG. 12a;

FIGS. 16a and 16b are three-dimensional side views of a sixth embodiment of a spike for the applicator device according to the invention;

FIGS. 17a to 19b are additional embodiment variants of the spike in FIG. 12a;

FIG. 20a is a top view of an embodiment variant of the spike in FIG. 5a;

FIG. 20b is a top view of a second variant of the spike in FIG. 5a;

FIGS. 21 to 24b are three-dimensional front views of embodiment variants of the spikes in FIG. 20; and

FIGS. 25a to 25c are three-dimensional, side and detail, views of a second embodiment of an applicator device according to the invention.

For greater clarity, identical or similar elements are identified by identical reference signs throughout the figures.

In the rest of this text, “applicator” or “applicator device” or “application device” are used to define the same technical means.

### DETAILED DESCRIPTION OF AN EMBODIMENT

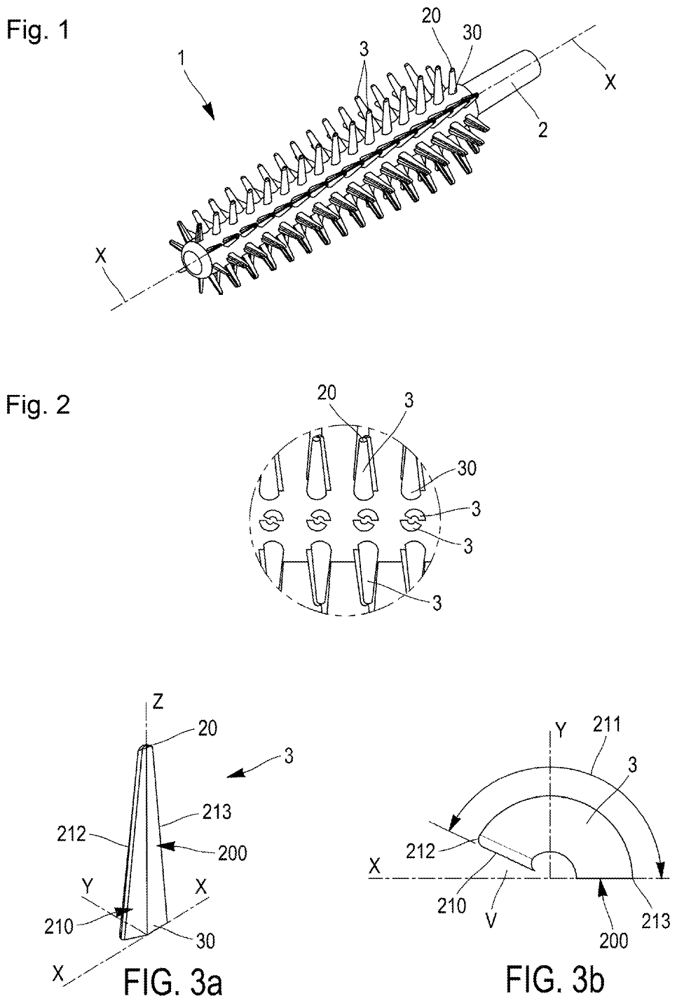

FIG. 1 and FIG. 2 illustrate the principle of the invention, which thus concerns an application device 1 for applying a product of fluid or pasty type to keratin fibers, such as eyelashes. As is known, this device comprises an elongate core 2 which extends along a longitudinal axis XX; the cross section of the core 2 may be constant or not constant. At least one row of spikes or protuberances 3, of elongate overall shape, comprises a first end 30 embedded in the core 2 and a free second end 20; the spikes 3 and the core 2 are advantageously made in one piece, notably made from plastic, by molding. Other methods for manufacturing/obtaining the applicator device 1 are possible: by removal of material, by addition of material (such as three-dimensional printing), etc. Materials that can also be used are thermoplastics or thermoplastic elastomers originating from fossil or plant resources. The application device 1 has an elongate overall shape and its outer volume can take various shapes: cylindrical, frustoconical, peanut-shaped, or the like; those skilled in the art will choose it depending on the precise scenario.

Without departing from the scope of the invention, the cosmetic product in question in this description could be liquid or semi-liquid; various applications can be envisaged. In particular, the cosmetic product is a product as defined in Regulation EC 1223/2009 of the European Parliament and Council of Nov. 30, 2009 relating to cosmetic products, and directive EU 94_62_EC, the US standard “California Proposition 65” or “REACH”. More generally, the cosmetic product intended to be applied by the cosmetic product applicator device 1 according to the invention can also take the form of a powder or a solid. It remains preferably in the form of a fluid or paste. It is a product intended to be deposited on a user's keratin fibers, such as the eyelashes or eyebrows: for example a mascara.

According to the invention, with reference to FIGS. 3a and 3b, a first embodiment of the spike 3 for the applicator device 1 according to the invention will be described in more detail. In this case, the spike 3 is delimited by a first flat face 200 which coincides or substantially coincides with a longitudinal plane referred to as joint plane, which extends radially with respect to the core 2 and passes through the longitudinal axis XX. In addition, in this case the spike 3 can be inscribed in a frustoconical shape of axis Z.

The spike 3 is moreover defined and delimited by a second flat face 210 which forms an angle 211 with the first flat face 200 of between approximately 91° and 180°. In a variant, the angle 211 is between 120° and 150°. Such an arrangement of the two faces 200 and 210 makes it possible to create a reservoir volume V for the cosmetic product, which is V-shaped in cross section and is open by an angle complementary to 180° with the angle 211 between the face 210 and the joint plane passing through the longitudinal axis XX. As a result, when the applicator device 1 according to the invention is taken out, the lips of the wiper slide along the edge corners 212 or 213 of the spike 3 without removing the cosmetic product within the reservoir volume V.

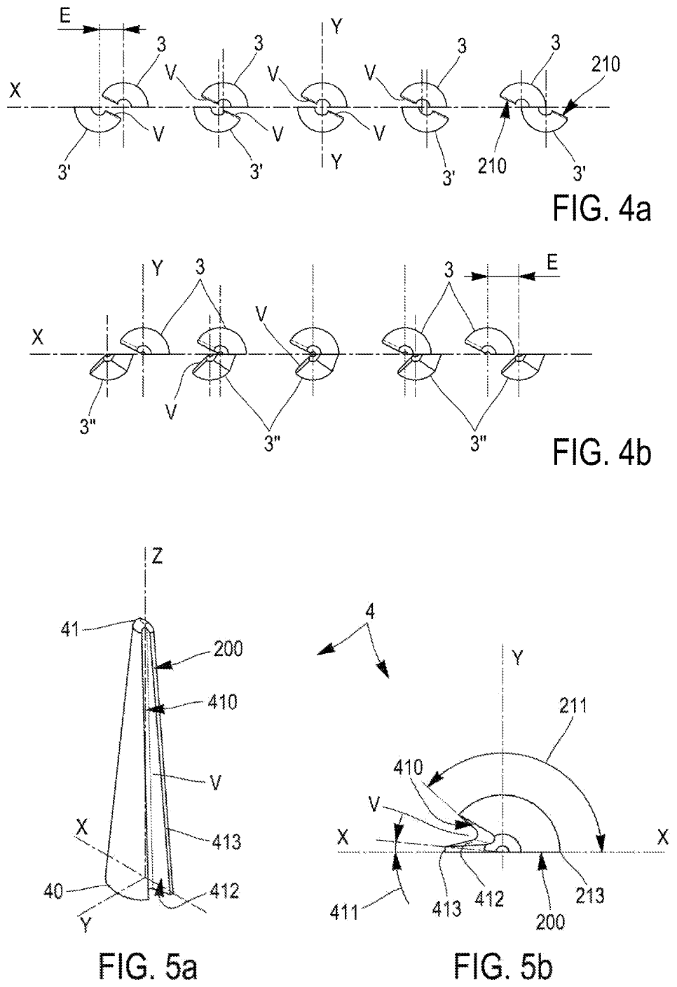

With reference to FIG. 4a, the disposition of two adjacent spikes 3, 3′ is such that a spacing E of between −2 mm and +2 mm can be measured along the longitudinal axis XX of the applicator device 1. In this instance, the orientation of two adjacent spikes 3, 3′ is not the same, since the two flat faces 210 are alternately on either side of the joint plane passing through the longitudinal axis XX, whereas the first faces 200 are part of said joint plane. The two spikes 3 and 3′ in this instance are symmetrical with a central symmetry, that is to say that the spike 3 is positioned at 180° in relation to the spike 3. This disposition makes it possible to form two reservoir volumes V in space on either side of the joint plane passing through the longitudinal axis XX that are oriented at 180° in relation to one another, and possibly a space connecting these reservoir volumes V.

Similarly, in a variant, with reference to FIG. 4b, the disposition of two adjacent spikes 3, 3″ is such that a spacing E of between −2 mm and +2 mm can be measured along the longitudinal axis XX of the applicator device 1. In this instance, the orientation of two adjacent spikes 3, 3′ is not the same, since the two flat faces 210 are alternately on either side of the joint plane passing through the longitudinal axis XX, whereas the first faces 200 are part of said joint plane. The two spokes 3 and 3″ in this instance are mirror-symmetrical in relation to the joint plane passing through the longitudinal axis XX. This disposition makes it possible to form two reservoir volumes V in space on either side of the joint plane passing through the longitudinal axis XX that are oriented in the same direction in relation to one another while still being mirror-symmetrical. For certain values of the spacing E, the two reservoir volumes V form one and the same volume, as illustrated in the second, third and fourth arrangements in FIG. 4b.

In all cases, the value of the spacing E will be chosen by those skilled in the art so as to be most suitable. It is possible to use a mixture of the spacings E for one and the same row of spikes 3, 3′, 3″. The same applies to the orientation of the spikes 3, 3′ and 3″.

Additionally, in all cases, the implantation of at least one of the spikes 3, 3′, 3″ is realized such that the reservoir volume V is oriented toward a free end of the core 2. This also applies to the spikes that will be described subsequently below. The same applies to the various implantation arrangements in FIGS. 4a and 4b.

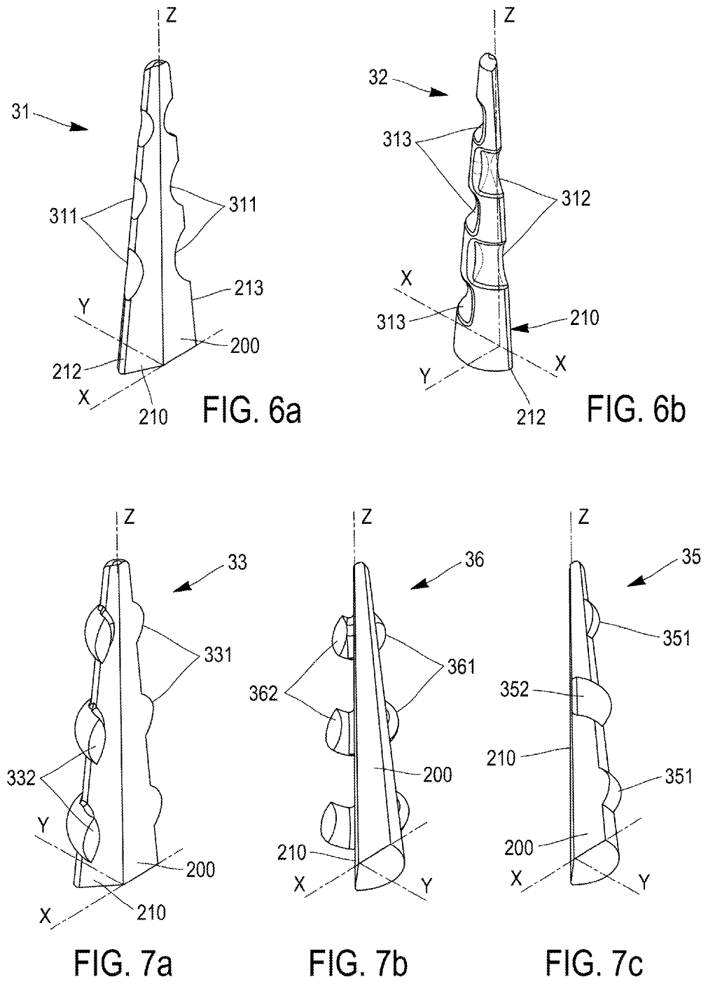

With reference now to FIGS. 6a to 9d, embodiment variants of the first embodiment of the spike 3 of an applicator device 1 according to the invention will be briefly described. The additional technical elements given to the spike 3 have the main function of allowing suitable application of the cosmetic product retained in the reservoir volume V and also guidance and possible separation of the keratin fibers in this particular application.

In FIG. 6a, the spike 31 moreover has recesses 311 distributed facing one another over the length of the edge corners 213 and 212.

In FIG. 6b, the spike 32 has notches 312 and 313 positioned in staggered fashion and extending on a frustoconical outer face of the spike 32 through approximately a half-angle 211 from the flat faces 200 and 210 respectively, in a plane perpendicular to the axis Z.

In FIG. 7a, the spike 33 has a series of beads 331 extending on a frustoconical outer face of the spike 33, in a plane perpendicular to the axis Z; the beads 331 extend from the flat face 200 through 180° to an end 332 that protrudes from the flat face 210. In this case, the beads 331 have a substantially elliptical shape in cross section.

In FIG. 7b, the spike 36 has beads 361 similar to the preceding beads 331, except that they do not extend as far as the flat face 200. However, they have an end 362 that protrudes from the flat face 210.

In FIG. 7c, the spike 35 has beads 351, 352 similar to the preceding beads 331. However, the beads 351 extend from the flat faces 200 and 210. The beads 351 and 352 in this case protrude further from the flat face 200. The beads 351 and 352 in this case alternate over a height of the spike 35: a bead 352 is between two beads 351.

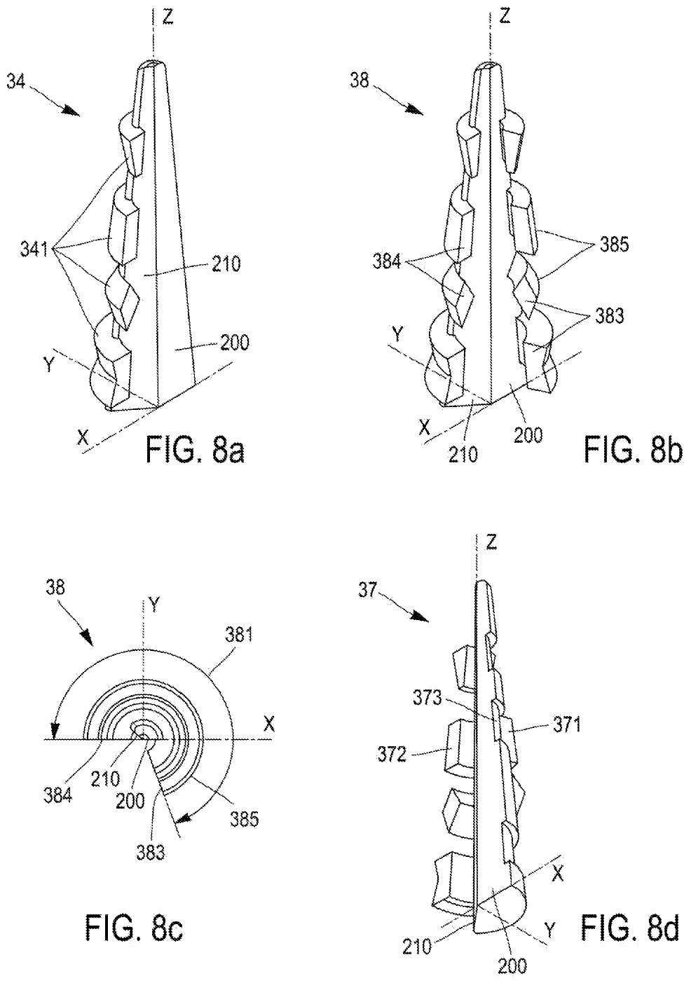

In FIG. 8a, the spike 34 has a series of variants 341 of the preceding beads 331. The beads 341 are distinguished, for the one part, by their polygonal cross section and, for the other part, by the fact that they do not extend to the flat face 200.

In FIGS. 8b and 8c, the spike 38 has beads 385 with similar cross sections to the preceding beads 341. However, the beads 385 have a first end 383 protruding from the flat face 200 and an end 384 protruding from the face 210. As a result, the beads extend through an angle 381, with it being possible for the end 384 to be in the joint plane passing through the longitudinal axis XX. The angle 381 may be between 1° and 290°.

In FIG. 8d, the spike 37 has a variant of the spike 38. It is distinguished by the fact that the beads 371 do not extend to the flat face 200, but are extended to said flat face 200 by a recess 373. Their ends 372 protrude from the face 210 as far as possibly being in the plane of the flat face 200.

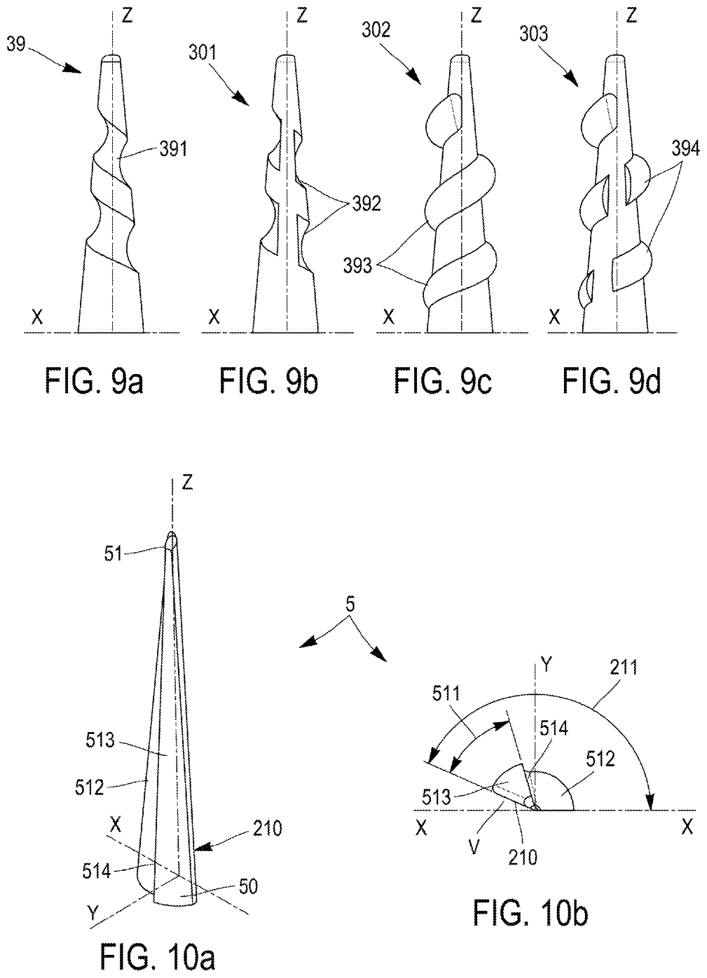

In FIG. 9a, the spike 39 has a continuous helical recess 391 on its frustoconical face. In FIG. 9b, the spike 301 has portions 392 of a helical recess similar to the recess 391 but discontinuous.

By contrast, in FIG. 9c, the spike 302 has a continuous helical bead 393 on its frustoconical face. In FIG. 9d, the spike 303 has portions 394 of a helical bead similar to the bead 393 but discontinuous.

With reference now to FIGS. 5a and 5b, a second embodiment of a spike 4 for an application device 1 according to the invention will be described in more detail. As for the embodiment described above, the spike 4 can be inscribed in a frustoconical shape of axis Z.

In this instance, the spike 4 has a first end 40 embedded in the core 2 and a free second end 41. It is delimited by a first flat face 200 which coincides or substantially coincides with a longitudinal plane referred to as joint plane, which extends radially with respect to the core 2 and passes through the longitudinal axis XX.

The spike 4 is moreover defined and delimited by a second flat face 410 which forms an angle 211 with the first flat face 200 of between approximately 91° and 180°. In a variant, the angle 211 is between 120° and 150°. In addition, the spike 4 has a third flat face 412 forming an angle 411 with the first flat face 200 of between approximately 1° and a value complementary to 180° of the angle 211 minus 1°. Such an arrangement of the two flat faces 410 and 412 makes it possible to create a reservoir volume V for the cosmetic product, which is “V”-shaped in cross section and is open by an angle complementary to 180° with the total of the angles 211 and 411 between the flat face 410 and the flat face 412. As a result, when the applicator device 1 according to the invention is taken out, the lips of the wiper slide along the edge corners 212 or 413 of the spike 4 without removing the cosmetic product within the reservoir volume V.

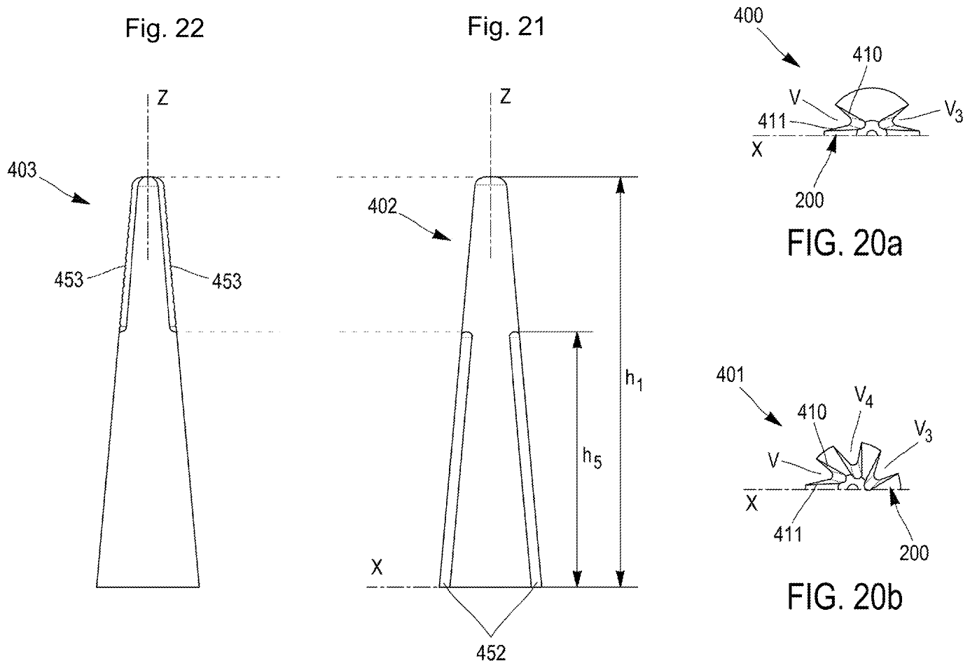

With reference to FIG. 20a, the spike 400 shown in a top view is a first embodiment variant of the preceding spike 4. The spike 400 has a second longitudinal groove delimiting an additional reservoir volume V3 which is mirror-symmetrical in relation to the reservoir volume V with respect to a plane passing through the axes Y and Z. In general, the spike 400 may have multiple longitudinal grooves of the same type distributed over a periphery of the frustoconical face of the spike 400: for example, the spike 401 in FIG. 20b has three of them delimiting the reservoir volumes V, V3 and V4. Other quantities may be provided, up to 20 for example.

FIG. 21 shows an embodiment variant of the spike 400. In this instance, the spike 403 has longitudinal grooves 453 made in the upper part of the spike 403, the bottom of the grooves 453 being at a height h5 from the embedded end of the spike 403.

Symmetrically, in FIG. 22, the spike 402 has longitudinal grooves 452 which are made in the lower part and extend over a height h5 from the embedded end of the spike 402.

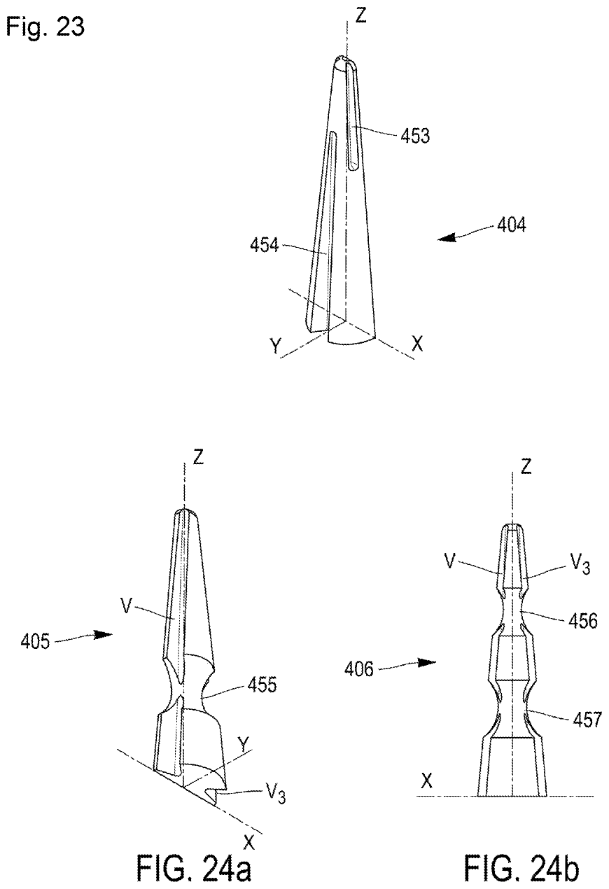

In FIG. 23, the spike 404 shown is an embodiment variant combining the embodiment variants of the spikes 402 and 403: it has, in succession, elongate grooves 453 in the upper part of the spike 404 and elongate grooves 454 in the lower part of the spike 404. The elongate grooves 453, 454 are staggered.

FIGS. 24a and 24b show two additional embodiment variants of the spike 400. The spike 405 has an annular recess 455 formed in a plane perpendicular to the axis Z of the spike 405. The spike 406 has two annular recesses 456, 457 similar to the preceding recess 455 which are distributed over the height of the spike 406.

With reference to FIGS. 10a and 10b, a third embodiment of a spike 5 for an applicator device 1 according to the invention will now be described. The spike 5 is based on the spike 2 described above. It has a first end 50 embedded in the core 2 and a free second end 51. However, it has at least two adjacent frustoconical sections 512 and 513 on its frustoconical face, the frustoconical face of the section 513 having an “overthickness” in relation to the frustoconical face of the section 512. The spike 5 thus has a longitudinal rim 514 between the two sections 512 and 513 that extends between the two ends 50 and 51. The section 513 extends from the flat face 210 through an angle 511 of between 1° and 177° without exceeding the angle 211.

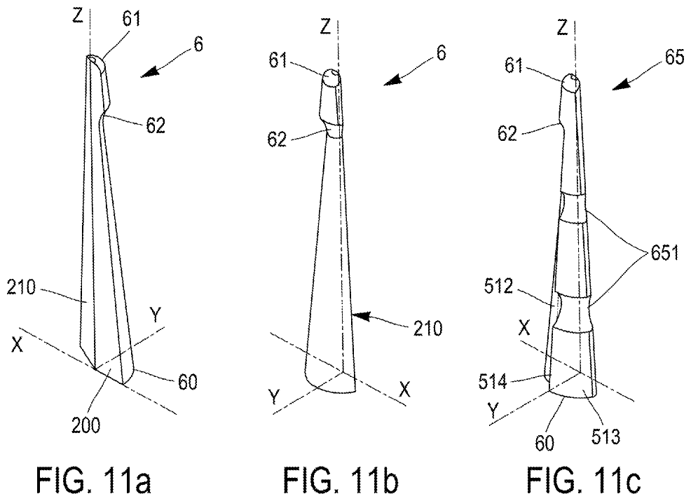

With reference to FIGS. 11a and 11b, a fourth embodiment of a spike 6 for an applicator device 1 according to the invention will now be described. The spike 6 is again based on the spike 2 described above. It has a first end 60 embedded in the core 2 and a free second end 61. However, the free end 61 is a frustoconical part with an “overthickness” in relation to the rest of the frustoconical face of the spike 6. As a result, the spike 6 has an annular rim 62 extending in a plane perpendicular to the axis Z from the flat face 210 to the flat face 200. The rim 62 extends from the free end 61 over a height of about 0.05 to 0.95 times the height of the spike 6.

FIG. 11c illustrates an embodiment variant 65 of the spikes 5 and 6 described above: the spike 65 reprises the two frustoconical sections 512 and 513 of the spike 5 and also the longitudinal edge 514. It also reprises the frustoconical part with an “overthickness” at the end 61 which is then in line with the frustoconical section 513 and the annular rim 62. The longitudinal rim 514 then extends from the end 60 to the annular rim. The annular rim 62 extends from the flat face 200 to the longitudinal rim 514. In addition, the spike 65 has a series of annular recesses 651 formed in a plane perpendicular to the axis Z on the outer surface of the frustoconical section 513.

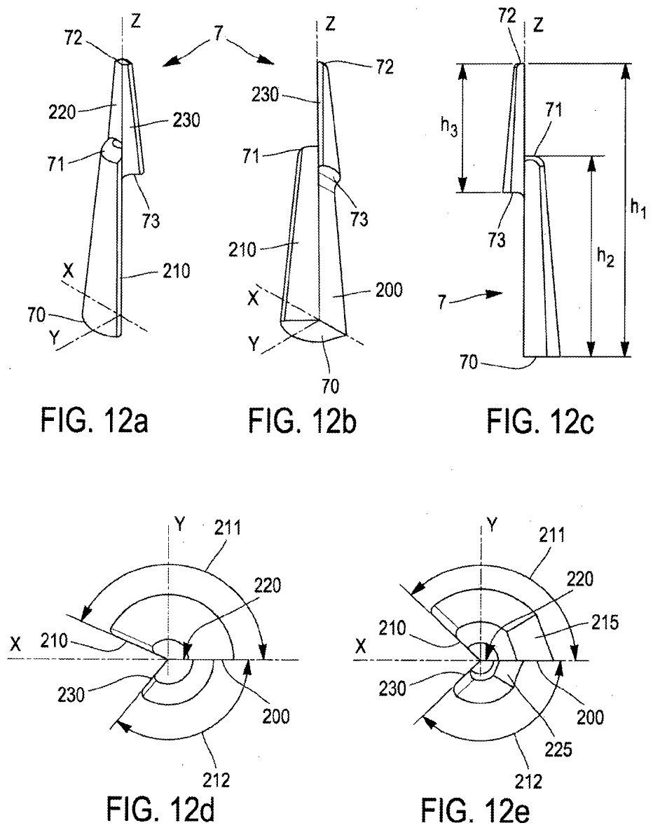

With reference to FIGS. 12a to 12d, a fifth embodiment of a spike 7 for an applicator device 1 according to the invention will be described. The spike 7, of height h1, is again based on the spike 2 described above. It has a first end 70 embedded in the core 2 and a free second end 72. The spike 7 is made of two superposed parts: the first part extends from the end 70 embedded in the core 2 to a first intermediate end 71, over a height h2. This first part is in this instance similar to the spike 3 described above. The second part extends from the free end 72 to a bottom end 73 over a height h3 from the free end 72. Again, the second part is similar to the spike 3 described above in that it has a first flat face 220 in the joint plane passing through the longitudinal axis XX and a second flat face 230 forming an angle 212 with the first flat face 220 of between approximately 91° and 180°. In a variant, the angle 212 is between 120° and 150°. The second part is mirror-symmetrical in relation to the first part. The flat faces 200 and 220 are in the same joint plane passing through the longitudinal axis XX and face one another. The second part is “superposed” on the first part between the bottom end 73 and the intermediate end 71 where the flat faces 210 and 220 coincide.

In a first embodiment variant illustrated in FIG. 12e, the first part has a first prismatic flattened portion 215 adjacent to the first flat face 200 and the second part has a second prismatic flattened portion 225 adjacent to the flat face 220.

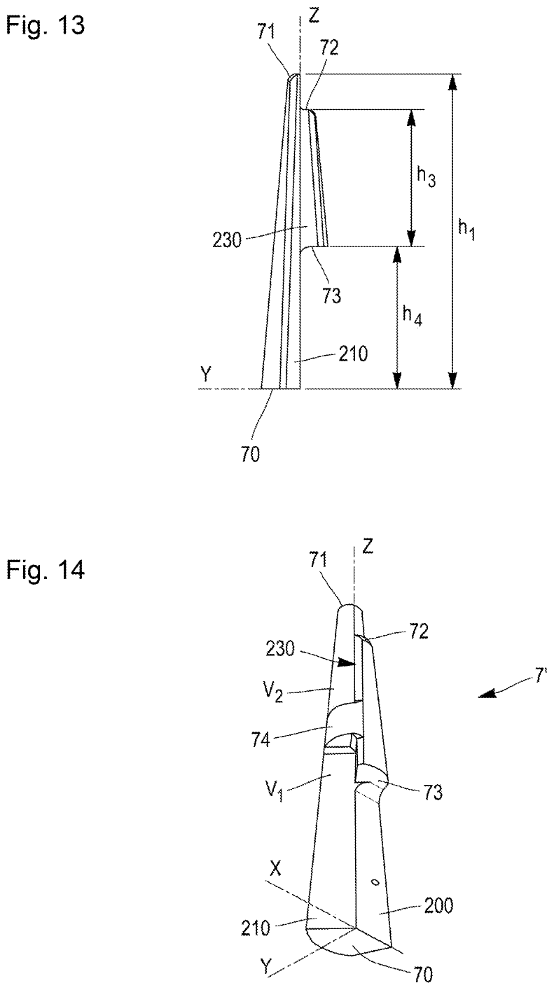

In a second variant illustrated in FIG. 13, the second part is superposed entirely on the first part, the bottom end being at a height h4 from the embedded end 70. This embodiment variant may include the prismatic flattened portions 215 and 225.

In the embodiment variant of the spike in FIG. 13, the spike 7′ in FIG. 14 moreover has a ring portion 74 extending from the flat face 210 of the first part to the flat face 230 of the second part. This makes it possible to divide the original reservoir volume V into two reservoir sub-volumes V1 and V2 that are superposed over the height of the spike 7′.

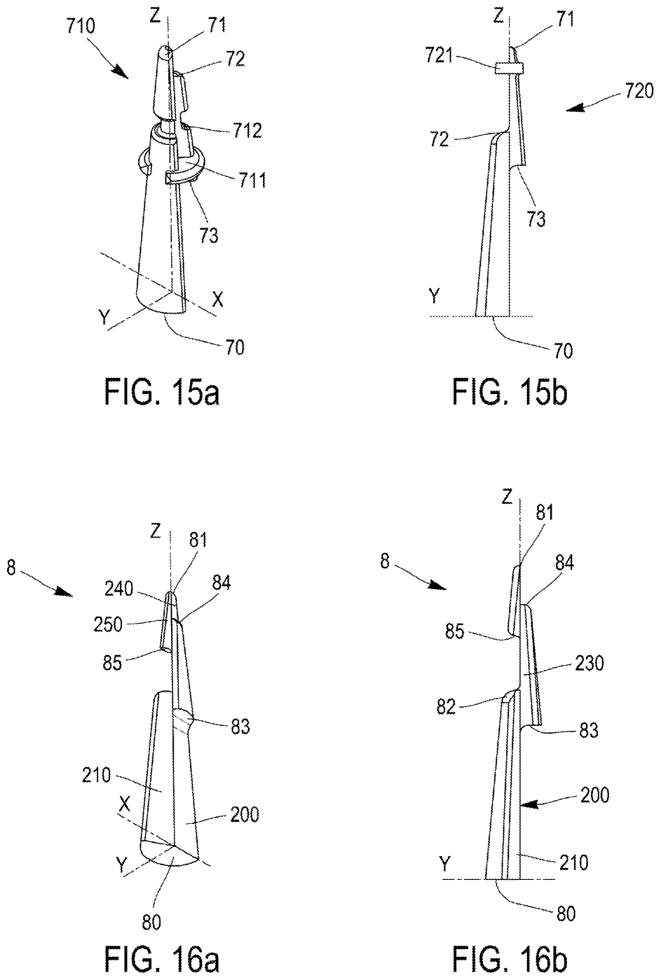

In FIG. 15a, the spike 710 is distinguished from the spike in FIG. 13 by the fact that it has a protruding disk portion 711 in a plane perpendicular to the axis Z at the bottom end 73 and an annular recess extending on the outer face of the first and second parts of the spike 710.

In FIG. 15b, the spike 720 is a spike 7 to which has been added a disk 721 which protrudes in a plane perpendicular to the axis Z and is positioned on the second part of the spike 720 below the free end.

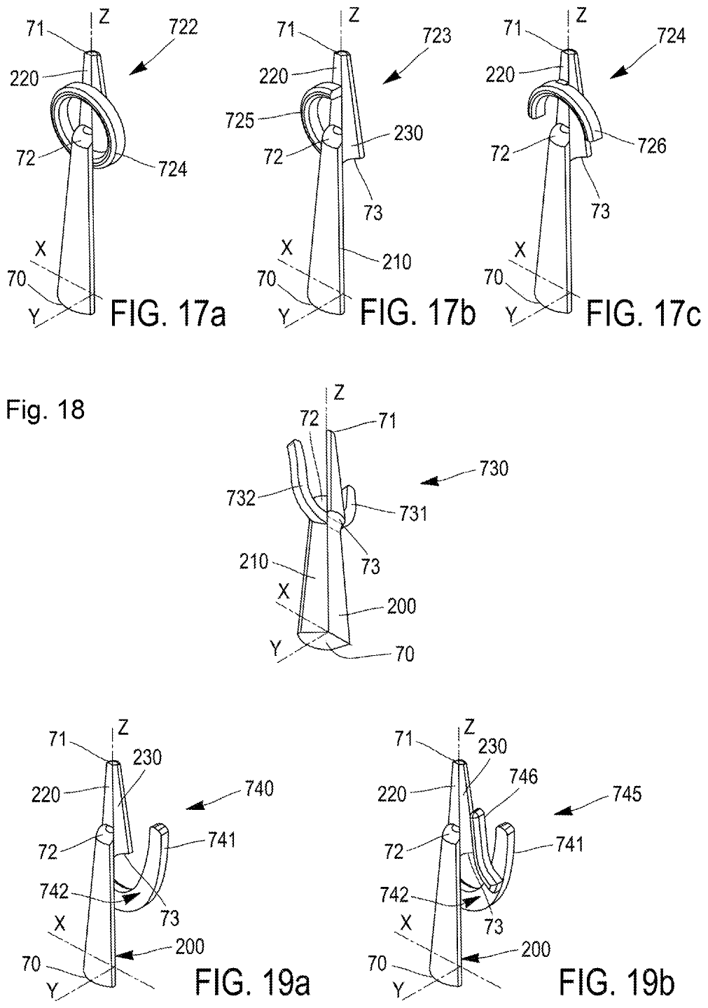

FIGS. 17a to 17c illustrate variants 722 to 724 of the spike 7. The spike 722 has a ring 724 which bears against the flat face 220 above the intermediate end 72 and is anchored in the first part below the bottom end 73. The ring 724 is in a plane parallel to the joint plane comprising the flat face 220. Instead of the ring 724, the spike 723 has a half-ring 725 which is at the rear of the flat faces 210 and 230, the bottom of the half-ring being anchored in the first part and the top of the half-ring bearing against the flat face 220. The spike 724 for its part instead of the ring 724 also has a half-ring 726 which is identical to the half-ring 725 but rotated by 90° so as to be suspended bearing against the flat face 220, the two ends of the half-ring 726 being free.

In FIG. 18, the spike 730 is similar to the spike 7. It is distinguished from the latter by the presence of two extensions 731 and 732 on either side of the second part of the spike 730. The two extensions 731 and 732 are anchored in the first part at the bottom end 73 and extend parallel to the axis Z of the spike 730. The two extensions face the flat face 220 and are at the rear of the flat face 200.

In FIG. 19a, the spike 740 is based on the spike 7 to which has been added a branch 741, curved in this instance, which extends overall along the axis Z of the spike 740 facing and spaced apart from the flat face 230 of the second part of the spike 740. The branch 741 has a flat face 742 which is in the plane of the flat face 200 and in the plane containing the flat faces 200 and 220.

In FIG. 19b, the spike 745 is an embodiment variant of the spike 740 and is distinguished from the latter by the presence of a second branch 746 bearing against the face 742 of the branch 741. The second branch 746 extends overall along the axis Z of the spike 745 and faces and is spaced apart from the flat face 230 of the second part of the spike 745 between the second part of the spike 745 and the branch 741.

With reference to FIGS. 16a and 16b, a sixth embodiment of a spike 8 for the applicator device 1 according to the invention will be now described. The spike 8 is based on the spike 7 described above in the sense that it reprises the first part between an anchoring end 80 for anchoring in the core 2 and an intermediate end 82, and a second part “superposed” on this first part between a bottom end 83 and an upper end 84. In addition, the spike 8 has a third part which is “superposed” on the second part and extends between a lower end 85 and a free end 81 of the spike 8. The third part is “superposed” on the second part in the same way as the “superposition” of the second part on the first part.

Furthermore, the number of rows of spikes preferably varies from one to twenty-four, with identical or non-identical spikes and arrangements of spikes. In particular, the spikes may all be oriented in the same way in one and the same row or over the set of spikes making up the application device; the spikes may also have different orientations, for example alternating on either side of the longitudinal plane P.

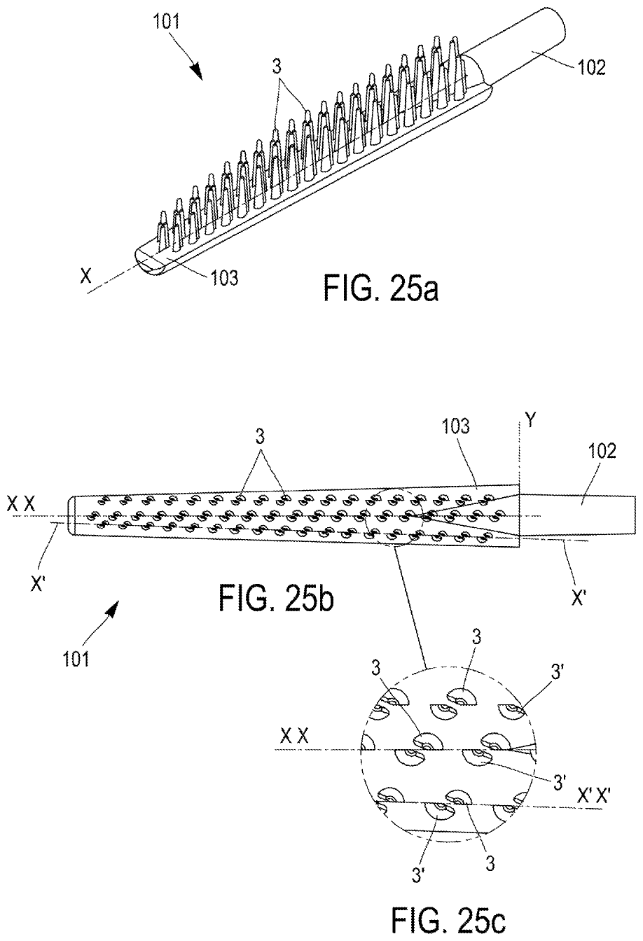

With reference to FIGS. 25a to 25c, a second embodiment of an applicator device 101 according to the invention will be now described. It should be noted that all of the preceding text concerning the spikes also applies to this applicator device 101 according to the invention. The applicator device 101 according to the invention is in this instance a comb having a core 102 of longitudinal axis XX comprising, over most of a length, a substantially flat face 103 which is parallel to the longitudinal axis XX and extends from a free end of the core 102. In the version illustrated, the applicator device 101 according to the invention has at least one row of spikes or protuberances 3 (in this case there are three rows). The rows may be parallel to one another or have an angle between one another, as illustrated here. In particular, at least one row is implanted along an implantation axis which is parallel to the longitudinal axis XX, and one of the adjacent rows along an implantation axis X′X′ forming an angle with the longitudinal axis XX, the other of the adjacent rows being implanted mirror-symmetrically in relation to one of the adjacent rows with respect to the row parallel to the longitudinal axis XX. For the illustration, the spikes 3, 3′ are implanted in a row like one of the arrangements in the previous FIG. 4a. Any other implantation is possible, including those described above. The same applies for the spikes in the rows which may be in accordance with the other embodiments described above.

In this embodiment of the applicator device 101 according to the invention, the longitudinal planes, referred to as joint planes, of each of the spikes 3, 3′ are perpendicular to the substantially planar face 103 of the core 102 and pass through the implantation axis X′X′ of the row of spikes in question.

Other, non-essential modifications may be provided either regarding the intrinsic shape of the spikes or regarding their mutual disposition and/or orientation, without departing from the scope of the invention. Of course, the applicator device according to the invention may have spikes from different embodiments according to the invention, notably those illustrated and described above.

Naturally, those skilled in the art will know to dimension notably the spikes, the spacings between the spikes, and the core in order to meet the necessary technical requirements.

Of course, it is possible to make numerous modifications to the invention without departing from the scope thereof.

1.-13. (canceled)

14. An applicator device for applying a product of fluid or pasty type to keratin fibers or to the skin, comprising:
an elongate central core, the elongate central core extending along a longitudinal axis XX, and
at least one row of elongate spikes comprising a first end embedded in the elongate central core and a free second end,
wherein the spikes and the elongate central core are made in one piece,
wherein at least one of the spikes is delimited by a first flat face which coincides with a longitudinal plane passing through the longitudinal axis XX of the central core, referred to as joint plane, and by a second flat face forming a first angle with said first flat face of between 91° and 179°, and
wherein the arrangement of the first and second flat face delimiting a reservoir volume V for cosmetic product.

15. The applicator device as claimed in claim 14, wherein the at least one of the face includes a third flat face forming a second angle with the first flat face of between 1° and a value complementary to 180° of the first angle minus 1°, the third flat face delimiting the reservoir volume V for cosmetic product that takes the form of a longitudinal groove.

16. The applicator device as claimed in claim 14, wherein the at least one spike has a frustoconical shape and includes a first and second adjacent frustoconical sections, the second frustoconical section having an overthickness in relation to the first frustoconical section, with a longitudinal rim separating the two frustoconical sections.

17. The applicator device as claimed in claim 14, wherein the wherein the at least one spike has a frustoconical shape, the free end of the at least one spike having a frustoconical part with an overthickness in relation to the rest of the at least one spike, the at least one spike further including an annular rim separating the frustoconical part with an overthickness from the rest of the at least one spike.

18. The applicator device as claimed in claim 14, wherein the at least one spike has first and second parts superposed, over some of each of their heights, one on the other along a longitudinal axis of the at least one spike, the first part being delimited by the first and second flat faces, the second part protruding from the first part.

19. The applicator device as claimed in claim 18, wherein the second part has an overall shape which is mirror-symmetrical in relation to the first part.

20. The applicator device as claimed in claim 18, wherein the second part is superposed entirely over some of the height of the first part, between ends of the first part.

21. The applicator device as claimed in claim 18, wherein the at least one spike has a third part superposed on the second part over some of each of their heights, one on the other along a longitudinal axis of the spike, the third part protruding from the second part.

22. The applicator device as claimed in claim 14, wherein the at least one spike has elements protruding from an outer surface of the at least one spike.

23. The applicator device as claimed in claim 14, wherein the at least one spike has elements that are extending recessed from an outer surface of the spike.

24. The applicator device as claimed in claim 14, wherein at least two of the spikes making up a row and including the at least one spike have an identical orientation.

25. The applicator device as claimed in claim 14, wherein at least two of the spikes making up a row and including the at least one spike have a different orientation.

26. The applicator device as claimed in claim 14, wherein the distance measured along the axis XX between two successive spikes of the at least one row is zero or positive.

27. The applicator device as claimed in claim 26, wherein the distance measured along the axis XX between two successive spikes of the at least one row is less than approximately 2 millimeters.
